(19) United States
(12) Patent Application Publication
(10) Pub. No.: US 2010/0080953 A1
(43) Pub. Date: Apr. 1, 2010

(54) Formation of Imprints and Methodology for Strengthening a Surface Bond in a Hybrid Ceramic Matrix Composite Structure

(75) Inventors: Gary B. Merrill, Orlando, FL (US); Jay A. Morrison, Oviedo, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS POWER GENERATION, INC., Orlando, FL (US)

(21) Appl. No.: 12/238,897

(22) Filed: Sep. 26, 2008

(51) Int. Cl. B32B 3/12; B05D 3/12

(52) U.S. Cl. 428/116; 427/299

(57) ABSTRACT

A hybrid ceramic matrix composite structure and method for fabricating such an structure are provided. A ceramic matrix composite substrate 12 includes a plurality of layers of ceramic fibers. A plurality of spaced apart imprints 22 is disposed in at least one of the plurality of layers. An outer surface of a subsequent layer disposed over the layer with the imprints to influence a texture of the outer surface of the substrate by defining a plurality of indent regions 32 on the outer surface of the substrate. A ceramic coating 14 is deposited on the surface of the substrate. The plurality of indent regions 32 constitutes a bond-enhancing arrangement between the surface of the substrate and a corresponding boundary of the coating.

### FIELD OF THE INVENTION

The present invention is generally related to ceramic structures for use in a high temperature combustion environment, and, more particularly, to structural arrangements and techniques for strengthening a surface bond between corresponding surfaces of an insulating ceramic coating and ceramic matrix composite (CMC) substrate, which is thermally protected by the ceramic coating.

### BACKGROUND OF THE INVENTION

Engine components in the hot gas flow of modern combustion turbines are required to operate at ever-increasing temperatures as engine efficiency requirements continue to advance. Ceramics typically have higher heat tolerance and lower thermal conductivities than metals, particularly in the case of oxide-based ceramic materials. For this reason, ceramics have been used both as structural materials in place of metallic materials and as coatings for both metal and ceramic structures. Ceramic matrix composite (CMC) wall structures with ceramic insulation outer coatings, such as described in commonly owned U.S. Pat. No. 6,197,424, have been developed to provide components with the high temperature stability of ceramics without the brittleness of monolithic ceramics.

The versatility of an insulated CMC material may be influenced by the strength of the bond between the insulation and the structural CMC material. For example, some environments and/or engine components may require an incremental bonding strength relative to baseline bond strength. Accordingly, further improvements that increment the bonding strength between the insulation and the structural CMC material are desired.

### BRIEF DESCRIPTION OF THE DRAWINGS

The invention is explained in the following description in view of the drawings that show:

FIG. 1 is a partial cross-sectional view of a hybrid ceramic structure for use in a high temperature combustion environment.

FIG. 2 is an isometric view of an arrangement of successive layers of ceramic fibers in a CMC substrate and further illustrates an example arrangement of imprints that may be disposed on at least one of the plurality of layers.

FIG. 3 illustrates another example arrangement of imprints that may be disposed on at least one of the plurality of layers.

FIG. 4 is a top view of an indent arrangement configured to affect the textural characteristics of the outer surface of the ceramic substrate as such indent arrangement may result from the imprint arrangement of FIG. 2.

FIG. 5 is a comparative plot of examples of enhanced bonding strength, as obtained in accordance with aspects of the present invention, relative to a baseline bonding strength.

### DETAILED DESCRIPTION OF THE INVENTION

In accordance with one or more embodiments structures and methods for fabricating a hybrid ceramic matrix composite structure are described herein. In the following detailed description, various specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent. Moreover, repeated usage of the phrase “in one embodiment” does not necessarily refer to the same embodiment, although it may. Lastly, the terms “comprising”, “including”, “having”, and the like, as used in the present application, are intended to be synonymous unless otherwise indicated.

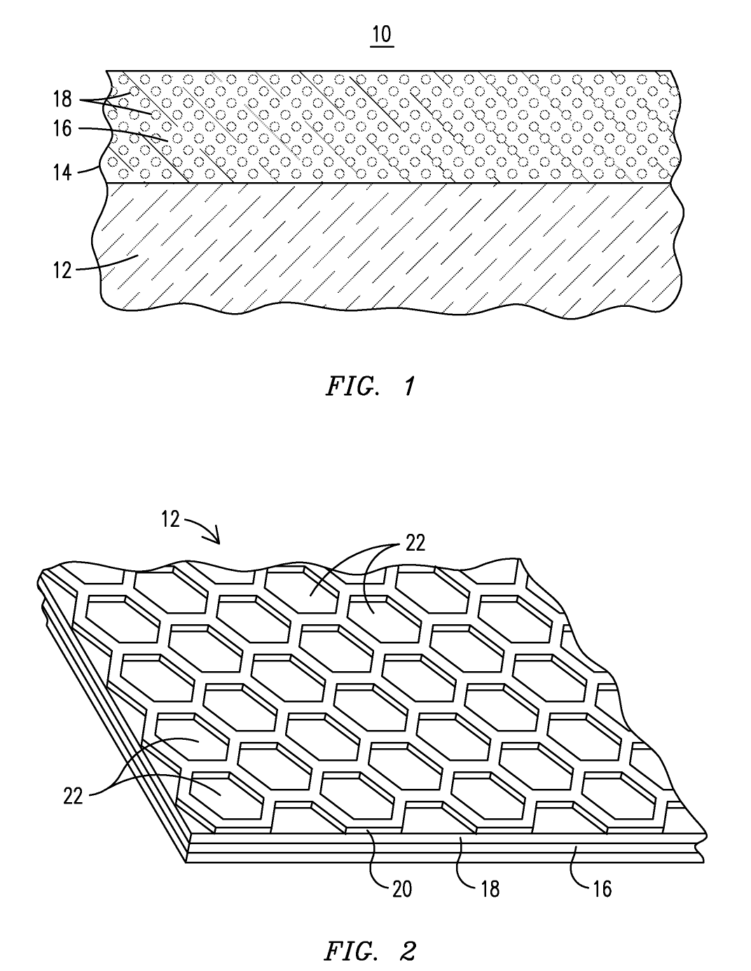

FIG. 1 is a partial cross-sectional view of a finished hybrid ceramic structure 10 for use in a high temperature combustion environment, such as in a gas turbine engine. The hybrid ceramic structure 10 is formed of a substrate 12 of an oxide-based ceramic matrix composite (CMC) material that is thermally protected by a thermally-insulating ceramic coating 14. The ceramic matrix composite substrate 12 and ceramic coating 14 may be of the type described in U.S. Pat. No. 6,013,592, incorporated by reference herein. The ceramic matrix composite substrate 12 includes at least one layer of ceramic fibers beneath a surface of the substrate. Ceramic coating 14 may be an oxide-based ceramic including a matrix material 16 surrounding a plurality of mullite (or alumina rich mullite) 18 geometric shapes (e.g., spheres). The matrix material 16 may include a mullite or alumina rich mullite filler powder and a phosphate binder or an alumina filler powder and an alumina binder. One or more optional oxide bond layers (not shown) may be disposed between the ceramic matrix composite substrate 12 and the ceramic insulating coating 14 and may comprise one or more of the group of mullite, alumina, and zirconia or other stable oxide materials of similar range coefficients of thermal expansion.

The inventors of the present invention propose structural arrangements and techniques conducive to strengthening a surface bond between corresponding surfaces of insulating ceramic coating 14 and CMC substrate 12. As shown in FIG. 2, CMC substrate 12 may be formed of a plurality of layers of ceramic fibers, such as layers 16, 18, and 20 and one or more subsequent layers (not shown in FIG. 2) that may be disposed over layer 20 to form a layering arrangement of successive layers of ceramic fibers.

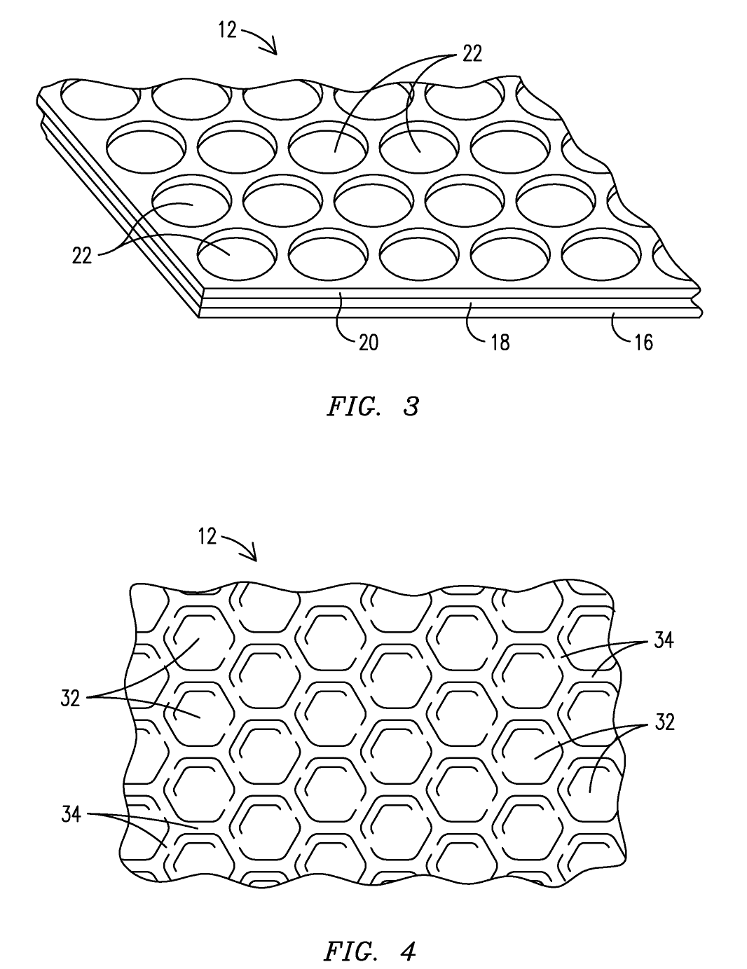

In one example embodiment, one can arrange a plurality of spaced apart imprints 22 (e.g., three-dimensional (3D) impressions, depressions or cutouts) in at least one of the plurality of layers (e.g., layer 20) prior to laying a subsequent layer of ceramic fibers onto layer 20. It will be appreciated that imprints 22 may be constructed, arranged and shaped in any of various forms. For example, imprints 22 may be formed by any device used to press, cutout, stamp, machine, or otherwise affect a shape of a corresponding structure to which such a device is applied. In the foregoing example, the corresponding structure shaped by any such device would be layer 20. The perimeter shape of imprints 22 may include cornerless arrangements as shown in FIG. 3 (e.g., circular shape, oval shape), or may include arrangements with corners as shown in FIG. 2 (e.g., polygonal shape) or a combination of the foregoing arrangements. The bottom surface of imprint 22 may be flat or curved (e.g., concave or convex). In another example embodiment, the spaced apart imprints may be distributed with a random distribution. It will be appreciated that the plurality of spaced apart imprints need not be arranged on a single layer. For example, the plurality of imprints may be arranged on at least two different layers.

An outer surface of a subsequent layer that may be disposed over the layer having the imprints influences a texture of the outer surface of CMC substrate 12 by defining indent regions on the outer surface of the substrate corresponding to the imprints. For example, one or more subsequent layers may be subjected to a suitable pressurization (or vacuuming) action relative to the layer with the imprints to ensure a compact joining between such layers. This may also provide effective infiltration to a slurry media, as may be used to fill any voids that may be created by the presence of the imprints.

For example, as illustrated in FIG. 4, a plurality of honeycomb-shaped indent regions 32 defined by protuberances 34 would produce a honeycomb-shaped textural characteristic on the outer surface of the ceramic substrate, as would result from the imprint arrangement shown in FIG. 2. It will be appreciated that the outer surface of the subsequent layer may be (but need not be) the outer surface of the substrate. For example, in the event that no subsequent layer is used, then the outer surface of the substrate would be the layer with the imprints 22.

The ceramic coating may then be deposited on the outer surface of the ceramic substrate where the plurality of indent regions 32 and protuberances 34 constitute a bond-enhancing arrangement between the outer surface of the ceramic substrate and a corresponding boundary of the coating. As will be appreciated by one skilled in the art, the ceramic coating is generally applied upon completion of various customary preliminary substrate processing steps—e.g., after substrate drying, partial curing, tooling removal and/or partial sintering.

It will be appreciated that the depth and inter-spacing of indent regions 32 can be adjusted for a given application based, for example, on any given fiber or fabric characteristics of the substrate and/or the expected size of bodies in the coating (e.g., hollow ceramic spheres). In one example embodiment, the inter-spacing and depth of indent-regions 32 may be configured to partially or completely accept the largest ceramic spheres that may be present in the coating. This may provide a fit to the spheres conducive to further increment the bonding and avoid or reduce characteristics of the interface that could promote crack propagation and delamination. In this example embodiment, the spacing between respective centers of such indent regions may range from about equal to the diameter (D) of the largest sphere to about an order of magnitude greater than the largest sphere's diameter (e.g., from about D to about 10 D). Similarly, the depth of the indent regions may range from about 20% to about 200% of the diameter (D) of the largest sphere (e.g., from about 0.2 D to about 2 D). For readers desirous of general background information regarding example considerations for choosing the inter-spacing and depth of the indent regions, in connection with achieving a desired fit with the spheres in the thermal coating, reference is made to U.S. patent application Ser. No. 11/600,709, filed on Nov. 16, 2006 titled “Ceramic Matrix Composite Surfaces With Open Features For Improved Bonding To Coatings”, assigned to the same assignee of the present invention and herein incorporated by reference.

It will be appreciated that the distribution of the imprints 22 and thus the resulting indent region distribution over the outer surface of the substrate may be suitably arranged to meet the bonding requirements of a given application in an optimized manner. For example, for interface regions where a bonding strength requirement may be relatively higher, (e.g., a leading edge of the component) the number of indent regions per unit of surface area (e.g., density) over such a region may be increased relative to a region with a lesser bonding strength requirement.

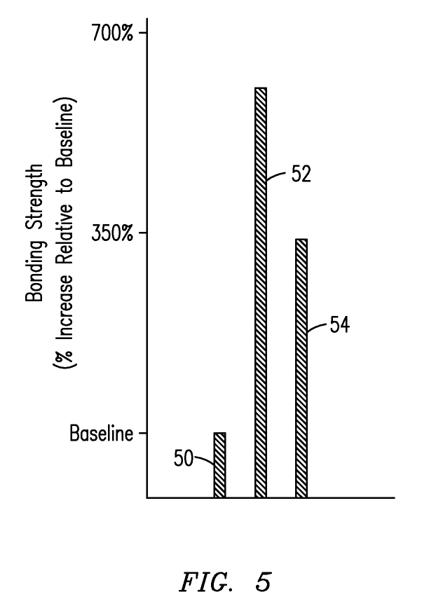

FIG. 5 is a comparative plot of examples of enhanced bonding strength, as obtained in accordance with aspects of the present invention, relative to a known baseline bonding strength represented by bar 50. Bar 52 represents an example of enhanced bonding strength obtained when using the example arrangement illustrated in FIG. 2 for the imprints with one or more layers over the imprints. Bar 54 represents an example of enhanced bonding strength obtained with the arrangement illustrated in FIG. 2 without any layers over the imprints.

While various embodiments of the present invention have been shown and described herein, it will be understood that such embodiments are provided by way of example only. Numerous variations, changes and substitutions may be made without departing from the invention herein. Accordingly, it is intended that the invention be limited only by the spirit and scope of the appended claims.

1-10. (canceled)

11. A hybrid ceramic matrix composite structure, comprising:
a ceramic matrix composite substrate including a plurality of layers of ceramic fibers;
at least one of the plurality of layers in the ceramic matrix composite substrate comprising a surface having a plurality of spaced apart imprints, wherein an outer surface of a subsequent layer disposed over said at least one of the plurality of layers with the imprints influences a texture of an outer surface of the substrate by defining a plurality of indent regions on the outer surface of the substrate; and
a ceramic coating deposited on the outer surface of the substrate, wherein the plurality of indent regions constitutes a bond-enhancing arrangement between the outer surface of the substrate and a corresponding boundary of the coating.

12. The structure of claim 11, wherein the outer surface of the subsequent layer is the outer surface of the substrate.

13. A hybrid ceramic matrix composite structure, comprising;
a ceramic matrix composite substrate including a plurality of layers of ceramic fibers;
at least one of the plurality of layers in the ceramic matrix composite substrate comprising a surface having a plurality of spaced apart imprints, wherein the surface of the layer with the imprints comprises an outer surface of the substrate; and
a ceramic coating deposited on outer surface of the substrate, wherein the plurality of spaced apart imprints constitutes a bond-enhancing arrangement between the outer surface of the substrate and a corresponding boundary of the coating.

14. The structure of claim 11, wherein the plurality of imprints is arranged on at least two different layers.

15. The structure of claim 11, wherein the plurality of imprints is arranged in accordance with a respective spatial distribution pattern.

16. The structure of claim 15, wherein the respective pattern is selected from the group consisting of a random pattern, a geometric pattern and a combination of said patterns.

17. The structure of claim 11, wherein the ceramic coating includes a plurality of hollow ceramic spheres.

18. The structure of claim 17, wherein the indent regions have a center-to-center separation distance that ranges from 100% to 1,000% of a diameter of the hollow ceramic spheres in the coating and a depth that ranges from 20% to 200% of the diameter of said hollow ceramic spheres.
